(19) United States
(12) Patent Application Publication
(10) Pub. No.: US 2005/0228705 A1
(43) Pub. Date: Oct. 13, 2005

(54) System and method for effectuating the planning and management of shipment pick-up and delivery appointments between buyers, sellers, and transportation and warehousing providers in a supply community

(76) Inventor: Charles F. Irwin, Guilford, CT (US)

Correspondence Address: Charles Y. Lackey, PO Box 5871, Winston-Salem, NC, 27113-5871, US

(21) Appl. No.: 10/822,103

(22) Filed: Apr. 12, 2004

(51) Int. Cl. G06F 17/60

(52) U.S. Cl. 705/8

(57) ABSTRACT

A method and apparatus for effectuating the shipment and appointment making process between buyers, sellers and third party service providers in a supply community. Any shipping location may create and maintain an appointment calendar within which one or more other participants may seek and select open time slots and request shipping reservations for unreserved slots. Operating hours, peak and off-peak hours, the duration of each dock time slot, any set aside time slots (left unreserved for exception events), and the appointment making lead-time window in the appointment calendar are specified by the shipping location. The shipping location can assign participants specific appointment making privileges and manually review and accept or reject appointment requests for requestors that have not been granted self-appointing privileges. The apparatus includes an internet-based program tool by which any participant can query and view only appointment information relevant to them, but including the entirety of a multi-participant multi-segment tour, such as a continuous move or a multi-stop pick-up and/or delivery shipments to facilitate participant collaboration in the planning of the multi-participant shipment.

### BACKGROUND OF THE INVENTION

(i) Field of the Invention

The present invention relates to collaborative transportation management between buyers, sellers, and transportation providers in a supply community, and more particularly to a method and system by which a transportation provider can schedule pick-up and delivery appointments for a shipment.

(2) Description of Prior Art

Business partners must collaborate to compete in today's marketplace, especially to drive growth by short-cycle innovation and to liberate the resources required to fund the growth initiatives. As buyers and sellers have increasingly focused on their core businesses and competencies, driving non-value added costs out of their supply chains has become strategic to increasing value to the buyer (and consumer) through lower prices and innovation. Many companies have restructured their supply chains reducing assets (plant and distribution center rationalization), costs (strategic sourcing initiatives, including out-sourcing), and inventory (integrated planning systems) to be faster, more flexible, and more efficient. Only then can the right product be introduced to the marketplace at the right time for the right cost.

These initiatives, unfortunately, are limited in scope in that they are primarily focused on improving the operations within a single enterprise. Significant step-change improvements in productivity require a cross-enterprise approach; the black box must be drawn around the seller, buyer, and their logistics providers. Only then can core supply chain processes such as inventory and production planning or order fulfillment execution be integrated so as to drive non-value added costs from the extended supply chain. Collaborative Planning, Forecasting, and Replenishment (CPFR) is receiving a lot of attention of late, and has the potential to dramatically reduce shelf stock-outs while simultaneously reducing total supply chain inventories.

The potential of CPFR and similar initiatives will only be fully realized, however, if the order fulfillment process has the capability to consistently and reliably deliver the right goods at the right time. Three steps in the order fulfillment process order entry, order delivery, and invoice settlement require effective cross-enterprise working. Two tools, Electronic Data Interchange (EDI) and (more recently) the Internet, have enabled business partners to systematically share transaction data, especially in order entry, shipment tendering and execution, and invoice settlement.
However, the process by which the shipper or the transportation provider (carrier) make pick-up and delivery appointments at the origin and destination ship locations has not, as of yet, benefited from these communication capabilities. The standard industry practice is for the requesting party (shipper or carrier) to telephone or fax the ship location. This process suffers from several significant deficiencies:
Effectiveness: The process is simply not effective. Two (very busy) individuals must be available at the same time. One party, typically the carrier, often has to hold until the other party is able to take the call. Wait times of 15 minutes or more are common. Furthermore, the appointment desk at many ship locations is not staffed 24/7. When it is closed, appointment planning for the shipment must wait until the desk reopens, even if the shipment is time critical. The planning window is then compressed and the risk of late delivery and increased costs (for expedited services) increases. Telephonic or facsimile exchange of shipment and planning information is also error prone.
Efficiency: The process is not efficient. As discussed above, establishing contact often wastes time. Furthermore, every shipment requires a contact. Even when a standing appointment has, the ship location typically requires the carrier to call to confirm the delivery.
Process and Data Visibility: The ship location is the only party that has visibility to that locations appointment calendar. This makes it difficult for the parties to explore multiple options for the delivery appointment; the carrier typically accepts the time offered by the ship location, even though there might very well be other open appointment times that would be equally acceptable to the location and better for the carrier. The lack of visibility also makes it impossible for the carrier to assess if they are being fairly treated, leading to suspicion and lack of trust. In addition, the shipper has no visibility to the source appointment data, and must rely on appointment data provided by the carrier via EDI transactions. Independent validation of the carriers performance versus plan is, therefore, impossible, hampering KPI-based continuous improvement efforts.
Complexity: The process is complex, involving many different persons, each with there own process preferences or style. Simply keeping track of the contact numbers is a daunting task, especially during staff transitions. This no doubt leads to frustration and failure. An integrated business process is needed everything in one place, managed the same way.

Presently, there are no commercially available and practicable solutions that overcome these barriers and limitations. Business partners are frustrated, with the process and with each other. Clearly a better solution is needed. Such a solution must not only address the above deficiencies, but must also be inexpensive and intuitive (easy to use).

### BRIEF SUMMARY OF THE INVENTION

The present invention is a method and apparatus for effectuating the shipment appointment-making process between one or many buyers and sellers, and their third-party service providers, (collectively called Partners) in a supply community. The present invention enables any Ship Location (SL), be it private or third-party, to create, configure, and maintain an appointment calendar (AC) within which one or many other Partners (particularly a carrier or a shipper) can contemporaneously query for open dock time slots and then submit pick-up and/or delivery appointment reservation requests for presently unreserved slots, wherein the operating hours, the peak and off-peak hours, the duration of each dock time slot, any set-aside time slots (left unreserved for exception events), and the appointment making lead-time window in the AC are specified by the ship location (SL). Furthermore, the SL can assign selected Partners specific appointment-making privileges, including pre-appointing, standing appointments (daily or weekly cycle), and self-appointing. The SL may choose to manually review and accept or reject the appointment requests or auto-accept the requests after a location-specified aging time, for any requestors that have not been granted self-appointing privileges. In a preferred embodiment, the apparatus of the present invention includes an internet-based program tool by which any Partner can query and view only appointment information relevant to them, but including the entirety of a multi-Partner multi-segment tour, such as a continuous move or a multi-stop pick-up and/or delivery shipments, so as to facilitate Partner collaboration in the planning of the multi-Partner shipment. Appointment actuals data is entered independently by the carrier and the SL; data record pairs that do not match as determined by the match tolerance criteria specified by the shipper are referred to the shipper for investigation and resolution.

Thus, there has been outlined the more important features of the invention in order that the detailed description that follows may be better understood and in order that the present contribution to the art may be better appreciated. There are, of course, additional features of the invention that will be described hereinafter and which will form the subject matter of the claims appended hereto. In that respect, before explaining at least one embodiment of the invention in detail, it is to be understood that the invention is not limited in its arrangement of the components set forth in the following description and illustrated in the drawings. The invention is capable of other embodiments and of being practiced and carried out in various ways.

It is also to be understood that the phraseology and terminology employed herein are for the purpose of description and should not be regarded as limiting in any respect. Those skilled in the art will appreciate that the concept upon which this disclosure is based may readily be utilized as a basis for designing other structures, methods and systems for carrying out the several purposes of this development. It is important that the claims be regarded as including such equivalent methods and products resulting therefrom that do not depart from the spirit and scope of the present invention. The application is neither intended to define the invention of the application, which is measured by its claims, nor to limit its scope in any way.

Thus, the objectives of the invention set forth below, along with the various features of novelty, which characterize the invention, are noted with particularity in the claims annexed to and forming a part of this disclosure. For a better understanding of the invention, its operating advantages and the specific results obtained by its use, reference should be made to the following detailed description taken in conjunction with the accompanying drawings wherein like characters of reference designate like parts throughout the several views.

The drawings are included to provide a further understanding of the invention and are incorporated herein and constitute a part of the specification. They illustrate embodiments of the invention and, together with their description, serve to explain the principles of the invention.

### BRIEF DESCRIPTION OF THE DRAWINGS

FIG. 1 is a block diagram illustrating the creation of an AC for a SL wherein the SL user must specify or select (i) calendar configuration information, (ii) criteria by which requests for appointments, including pre-appointments and standing appointments, will be automatically approved by the system, and (iii) the parameters by which the dwell time for a pick-up or a delivery appointment will be calculated.

FIG. 2 is a block diagram illustrating the method by which pre-appointments or standing appointments are requested by a seller or carrier planner and the SL approves or rejects appointment request that were not automatically approved by the system according to criteria specified by the SL.

FIG. 3 is a block diagram illustrating the method by which the carrier shipment planner (CSP) enters shipment attribute data into the system wherein the CSP may choose to enter the data on-line by completing a form or may choose to populate a form off-line and then upload the form into the system.

FIG. 4 is a block diagram illustrating the method by which the CSP requests delivery appointments for a shipment and the SL's accept or reject the requested appointment time wherein (i) the dwell time at the destination location is calculated by the system using the dwell time parameters entered by the SL Partner, (ii) the system automatically links the shipment with previously requested and accepted pre-appointments or standing appointments, (iii) the CSP views the appointment calendar for the SL and selects an appointment date and time that has a sufficient time slot for the calculated dwell time, and (iv) the SL approves or rejects appointment requests that were not automatically approved by the system according to criteria specified by the Location User.

FIG. 5 is a block diagram illustrating the method by which the CSP requests pick-up appointments for a shipment with an agreed delivery appointment and the SL's accept or reject the requested appointment time wherein (i) the dwell time at the origin location is calculated by the system using the dwell time parameters entered by the SL user, (ii) the transit time is calculated by the system using the transit time parameters entered by the carrier, (iii) the pick-up no later than date and time is calculated basis the delivery appointment, the transit time, and the origin dwell time, (iv) the system automatically links the shipment with previously requested and accepted pre-appointments or standing appointments, (v) the CSP views the appointment calendar for the SL and selects an appointment date and time that is before the pick-up no later than date and time and has a sufficient time slot for the calculated dwell time, and (vi) the SL approves or rejects the appointment requests that were not automatically approved by the system according to criteria specified by the SL user.

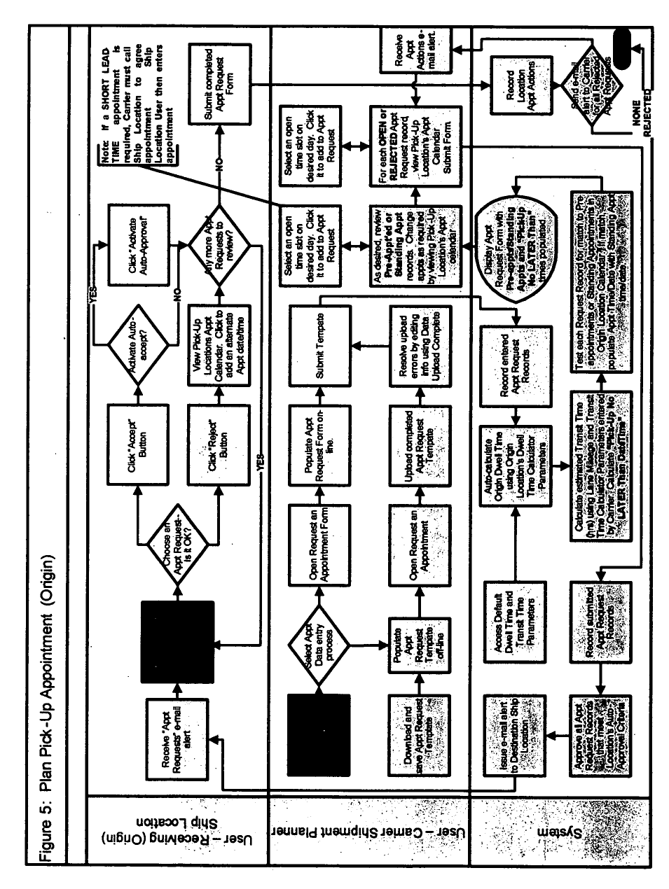

FIG. 6 is a block diagram illustrating the method by which actual data for a shipments and its appointments is entered by the carrier and the SL wherein the entered data is accepted only if the two entries satisfy match criteria entered by the shipper and shipments with non-matching appointment actuals data are investigated by the shipper.

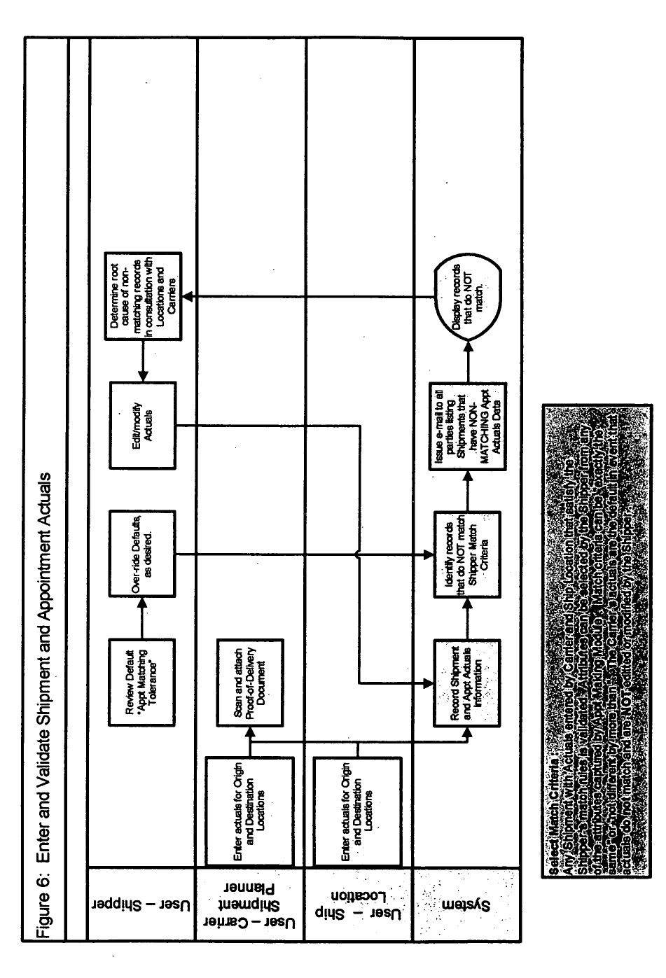

### DETAILED DESCRIPTION OF THE INVENTION

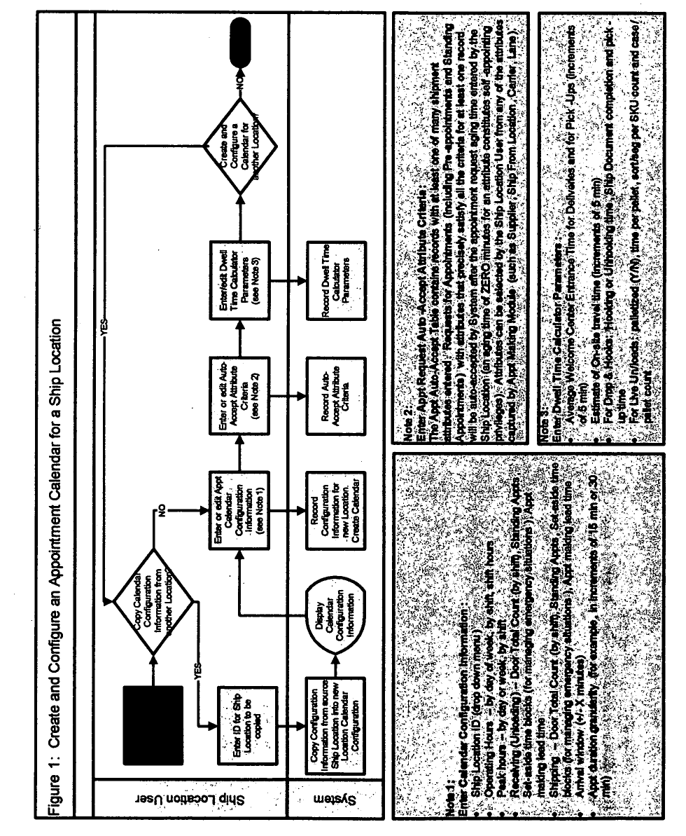

A SL user that desires to utilize the present invention to facilitate the making of pick-up or delivery appointments for shipments from or to that SL first creates an AC for the ship location by specifying attributes that enumerate the configuration of their appointment calendar, such as the operating hours, the peak hours, the receiving door count by shift, the shipping door count by shift, standing appointments and set-aside time blocks that will remain unreserved for emergency situations or deliveries planned outside of the system (such as less-than-truckload shipments), and the appointment lead time, arrival window, and appointment granularity (for example, appointment duration could be in increments of 30 minutes, or in increments of 15 minutes), as shown in FIG. 1.

The system then creates an AC for that ship location. Any partner may view appointments on the AC for a SL, but only appointments that are relevant to the partner. The SL user can also specify the criteria by which requests for appointments (by the carrier), pre-appointments (by the shipper or carrier), or standing appointments (by the shipper or carrier) will be automatically accepted by the system without ship location user intervention after the appointment has satisfied the aging time specified by the location. If the SL user specifies an AUTO-ACCEPT aging time of zero minutes for a particular criteria (such as a single carrier or shipper), then they are essentially granting self-appointing privileges to that Partner. Finally, the SL user enters parameters that will be used by the system to calculate an estimated dwell time for appointments, be they pick-up or delivery, or live load or drop and hook. This estimate of dwell time is necessary so that the duration of the appointment can be tailored for the attributes of the shipment. For example, shipments where the power unit must be present for loading or unloading will necessarily require a longer appointment than a drop trailer delivery or a pre-loaded shipmen pick-up. Similarly, a complex shipment (high SKU count) requiring carrier sort and segregation will require a longer appointment duration than a less complex shipment of single-SKU pallets.

The concept of peak hours is particularly noteworthy. All ship locations have periods of increased activity. By denoting these periods as peak periods, the ship location can then empower the party requesting the appointment to request a time during the non-peak period. This benefits both the location (by smoothing activity) and the carrier (by reducing the likelihood of delays).

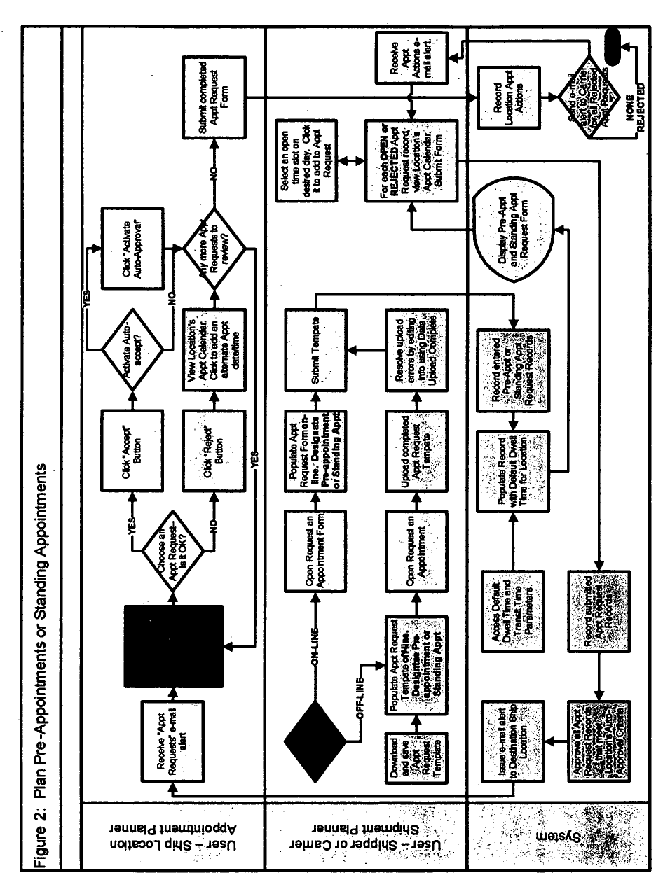

Shippers often desire to make pre-appointments for shipments, especially short lead-time shipments. In such a situation, the shipper will contact the customer destination ship location and agree upon a delivery appointment date and time before the shipment is tendered by the shipper to a carrier. The carrier then receives the shipment tender with the delivery appointment already pre-appointed on the tender. Similarly, shippers and customer destination ship locations often agree so-called standing appointments when shipments to a specific location can be planned for a specific order cycle, such as daily or weekly. As illustrated in FIG. 2, the shipper may request pre-appointed or standing appointments by completing the appointment request form (ARF) and selecting an open appointment time slot on the locations AC. The SL user must then accept or reject the request, unless the request has been auto-approved by the system. If the ship location chooses to reject the appointment request, they must select an alternate date and time which is then presented to the shipper.

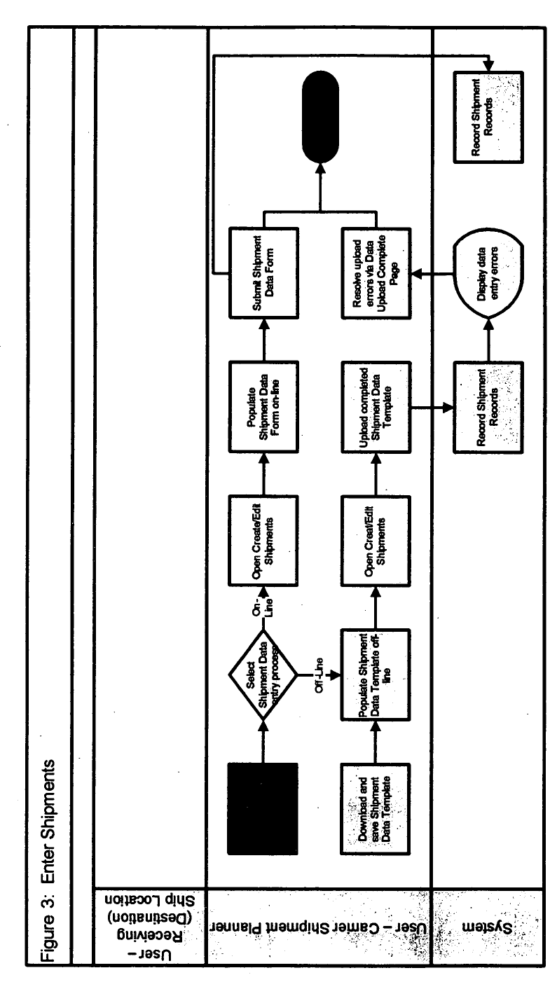

The method by which the carrier enters shipments into the system is illustrated in FIG. 3. Upon receiving one or many shipment tenders from a shipper, the carrier can choose to enter the shipment information on-line by completing and submitting a shipment data form (SDF), or by populating the same SDF off-line (preferably systematically by their shipment planning system) and then up-loading the SDF into the system. The up-load process comprises an error checking routine to ensure only correct data is entered.

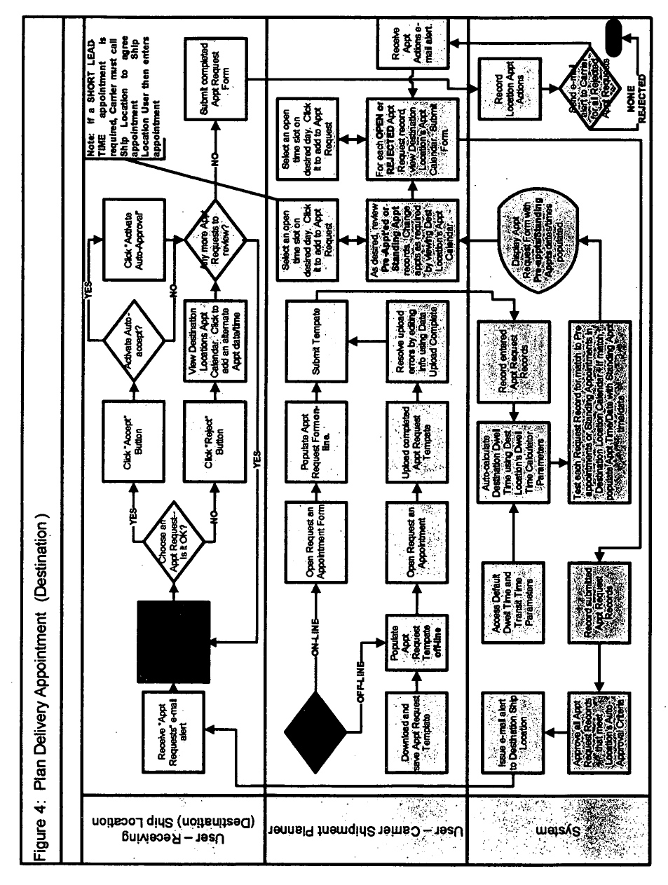

Each shipment has at least one pick-up appointment and at least one delivery appointment. Any number of these appointments (one or more) for a specific shipment can be planned by the carrier and the SL's as illustrated in FIG. 3 (delivery appointments) and FIG. 4 (pick-up appointments). Several aspects of these methods are particularly noteworthy.

The system auto-calculates an estimated dwell time for both the origin location and the destination location to ensure that the appointment duration is sufficient to load or unload the shipment.

For delivery appointments, the system tests each appointment request for a matching pre-appointment or standing appointment already in the AC for that SL. If a pre-appointment or standing appointment is located, that appointment is immediately assigned (attached) to the subject shipment.

For pick-up appointments, the system auto-calculates an estimated transit time based on the trip mileage and transit time parameters entered by the carrier in the carrier's master data records. This transit time and the origin pick-up dwell time are used to calculate a do not pick-up after date and time to ensure that the carrier selects a pick-up appointment date and time that leave sufficient time to honor the previously agreed delivery appointment date and time.

For both delivery and pick-up appointments, the carrier then queries the AC for the SL of interest. The carrier can, of course, see their own appointments and any open appointment slots that are sufficiently long as to accommodate the dwell time estimated by the system. Clicking an open appointment slot reserves that time period for the subject shipment and attaches that appointment slot to that shipment. The clear benefit of this method is that the carrier can see all open time slots and select the appointment time that is best for their operation. Appointment slots that are within the lead time (LT) parameter by the SL are visible to the carrier, but cannot be reserved by the carrier; instead, the carrier must call the SL and agree to the short-lead time appointment over the phone. The SL then enters the agreed appointment into the system.

The SL user is then responsible for viewing appointment requests, and accepting or rejecting each one. If the request is rejected, the appointment time slot is released and the SL user is asked to propose an alternate date and time. Appointment requests that have been auto-accepted by the system are so flagged; the SL user can over-ride the auto-acceptance if they so choose and reject the appointment request. If they reject an auto-accepted appointment request, the SL user has the option of deactivating auto-accept for that shipment criteria (lane, or carrier, or shipper). Similarly, if the SL user accepts an appointment request, they can then choose to activate auto-accept for that criteria for future appointment requests.

The present invention may be used by carriers and ship locations to facilitate the planning of complex shipments, such as shipments involving multiple shippers, multiple orders, or multiple stops. The carrier can access all the shipment and appointment information, whereas each SL can access only the information relevant to their order. The carrier is then able to construct a continuous move tour, reducing costs for all involved Partners.

After all the necessary pick-up and delivery appointments for a shipment are planned, the carrier and the SL's execute the shipment. Actuals for each shipment, such as the actual time of arrival and departure and accessorials provided by the carrier, are entered by both the carrier and each SL. To ensure independent validation and accuracy, each Partner cannot review or access the actual records for a single shipment. If the records match within the tolerance limits specified by the shipper, the system accepts the If the records match within the tolerance limits specified by the shipper, the system accepts the entered records as valid. Records that do not match the shipper's tolerance limits are referred to the shipper for investigation and resolution. Failing resolution, the system defaults to the data in the record entered by the carrier. The accepted records are then available for use the KPI module and the gainshare incentive (GI) module. Finally, the carrier enters the proof-of-delivery document into the system and attaches it to the subject record. For example, paper POD's are scanned in and then attached, whereas e-POD's can be directly browsed out and attached. The shipper is then able to search out POD documents for their shipments, dramatically reducing the effort presently required to request and secure POD documents from carriers. The shipper may also access the actual accessorial history for a shipment entered by the SL to assist in validating a freight bill submitted by the carrier.

The shipment and appointment creation and management method of the present invention can be incorporated in an int4ernet website application which will enable business Partners in the truckload transportation marketplace (shipper, consignees and carriers) collaboratively to: (a) make and confirm pick-up and delivery appointments for truckload shipments, (b) record and share key transactional data, including accessorials incurred and proof-of-delivery documents, (c) measure and improve performance on key service and cost performance indicators, and (d) create and manage incentive programs that reward business partners for meeting threshold targets on the key performance indicators.

Such an internet web-site application is preferably modular in design with each module comprised of a narrow set of related capabilities and independent of the other modules (sharing only a common administration module and an underlying data base). This modular design reduces complexity, simplifies development and maintenance, and ensures reliability.

The modular design also helps ensure that the application, and its capabilities are intuitive and easy to use, so as to encourage adoption and consistent use by all Partners. Users will also be provided data entry options a template (enter data into fields), manual Excel file uploads (or paste and copy), and an automated transfer server-to-server to ease integration with current systems, regardless of business practice or process.

The structure for the modules is as follows:

Customer Care Module (CCM: This module welcomes visitors and invited guests to the web-site, communicates the vision and program, and then provides the information that the prospective member will want and need to make their decision to join (such as site tours, sample program and reports, press releases and articles, and customer testimonials). After completing the registration process and selecting the desired services, the member is then cared for with information (news letters, bulletin board and market updates), communication tools (buttons to e-mail the administrator, submit improvement ideas or touch a partner), and training tools (frequently asked questions, learning tutorials, and Help!). Partner administrators are also able to manage their account and archive data.

Master Data Entry and Management Module (MDEMM): Each partner must enter and maintain its administrative data. First, the partner designates an administrator, who then configures and assigns roles to users at that partner. The administrator then creates a partner list naming those partners with whom they wish to collaborate. Each shipper and customer (consignee) must complete the SL profile for every SL. This profile records the information required by shippers and carriers to flawlessly plan and execute a shipment. The information is easily accessed and searched, and is maintained by the user responsible for that location. The SL user configures the AS for that location in the AC (for inbound and outbound shipments, as relevant). This schedule can be customized or changed to meet the needs of that location. Carriers complete a request for information survey that documents their capabilities. This information will be used by shippers to identify the carriers with the potential to offer the highest value against the shippers needs.

Enter and Maintain Transactions Appointments Module (EMTAM): This module is the data warehouse where the data that drives the performance and incentive modules is entered and managed. Here, CPU customers and their carriers request pick-up and deliver appointments by using the AC and the location then confirms the appointment. Actuals for each shipment (against the planned appointments) are entered, by both the carrier and the SL to ensure accuracy. Using an accessorial validation tool, the carrier and location independently indicate which accessorials were provided by the carrier while at the location. The shipper can then access or download this accessorial history to investigate discrepancies and to approve accessorials invoiced by the carrier. The carrier can scan and post proof of delivery documents for later use by the shipper to resolve deduction claims made by the customer.

Performance and Compliance Module (PCM): This module is a data analysis calendar that generates score card reports of the performance of each participating partner as compared to the minimum required performance level for each KPI. Users can also drill down through the data to determine the root cause of any KPI deviations against the required performance level. Examples of key performance indicators are: (a) on-time by location (versus appointment), (b) power dwell time by ship location and, (c)! trailer dwell times (turns) by drop location. This module is effective for monitoring compliance of the CPU customer to the CPU sponsor□s program policy and procedure.

Gainshare Incentive Program Creation and Management Module: (PCMM):

In this module, Partners can create and manage their own incentive program(s). This module is also effective for the settlement of CPU allowance credits calculated via the selected line haul rate structure algorithm.

Account Management Modul (AMM): In this module, the monthly financial statement for each partner is generated and posted. Receivables are invoiced and payments are issued for earned incentives. The partner administrator can review the account and approve each credit or debit to the account.

From the proceeding description, it can be seen that a shipment and appointment creation and management method and system has been provided that will meet all of the advantages of prior art programs and offer additional advantages not heretofore achievable. With respect to the foregoing invention, the optimum functional and dimensional relationship to the parts of the invention including variations in format, material, shape, form, function, and manner of operation, use and assembly are deemed readily apparent to those skilled in the art, and all equivalent relationships suggested in the drawings and described in the specification are intended to be encompassed herein.

The foregoing is considered as illustrative only of the principles of the invention. Numerous modifications and changes will readily occur to those skilled in the art, and it is not desired to limit the invention to the exact operation shown and described. All suitable modifications and equivalents that fall within the scope of the appended claims are deemed within the present inventive concept.

1. In a system for effectuating the shipment appointment-making process between one or more buyers and sellers and their third party providers (collectively called Partners) in a supply community, a process including the steps of: a ship location Partner creating, configuring, and maintaining an appointment calendar; one or more other Partners contemporaneously querying the appointment calendar for a specific ship location to determine available pick-up and delivery dock times; the one or more other Partners submitting an appointment reservation request to the ship location Partner; and the ship location Partner declining or accepting the appointment reservation request.

2. The process as claimed in claim 1 wherein the appointment calendar is created, configured, and managed in such a manner as to consider and incorporate the operating hours of the ship location and the number of dock doors in operation during those hours of operation, the peak and off-peak hours of the ship location for any reason, the duration of each dock time slot, any dock time slots set aside by the ship location for any reason and thereby unavailable to the one or more other Partners for requesting an appointment reservation, the lead-time required for requesting an appointment reservation of a dock time slot in the appointment calendar, the appointment reservation request auto-approval aging time, and the appointment-making privileges of the one or more other Partners as specified by ship location Partner.

3. The method as claimed in claim 2 wherein the appointment-making privileges specified by the ship location Partner include the privilege to request a pre-appointment, the privilege to request a repeating standing appointment, and the privilege to self-appoint appointments.

4. The method as claimed in claim 2 wherein the ship location Partner may elect to manually review and approve or decline the appointment reservation requests and to auto-accept the appointment reservation requests for any Partners that have not been granted self-appointing privileges by that ship location Partner after the appointment request auto-approval aging time specified by the ship location Partner has elapsed.

5. The method as claimed in claim 2 wherein the ship location is owned by at least one Partner.

6. The method as claimed in claim 2 wherein the ship location is a third-party owned facility serving one or more Partners.

7. The method as claimed in claim 2 wherein at least one Partner is a carrier.

8. The method as claimed in claim 2 wherein at least one Partner is a shipper.

9. The method as claimed in claim 1 wherein a Partner may query and view appointment information for any appointment reservation request and for any approved appointment reservation provided that the appointment reservation is relevant to that Partner including the entirety of a multi-Partner multi-segment tour so as to facilitate Partner collaboration in the planning of the multi-Partner shipment.

10. The method as claimed in claim 9 wherein the entirety of the multi-Partner multi-segment tour includes continuous move and multi-stop pick-up and delivery shipments.

11. A system for effectuating the shipment appointment-making process between one or more buyers and sellers and their third-party service providers (collectively called Partners) in a supply community, the system comprising: means by which a ship location Partner can create, configure and maintain an appointment calendar for the ship location; means for one or more other Partners to query the appointment calendar for a ship location to determine available pick-up and delivery dock times; means for the one or more other Partners to submit an appointment reservation request to the ship location Partner; and means for the ship location Partner to decline or accept the appointment reservation request.

12. The system as claimed in claim 11 wherein the appointment calendar is created, configured and managed in such a manner as to consider and incorporate the operating hours of the ship location and the number of dock doors in operation during those hours of operation, the peak and off-peak hours of the ship location for any reason, the duration of each dock time slot, any dock time slots set-aside by the ship location for any reason and thereby unavailable to the one or more other Partners for requesting an appointment reservation, the lead-time required for requesting an appointment reservation of a dock time slot in the appointment calendar, the appointment reservation request auto-approval aging time, and the appointment-making privileges of the one or more other Partners as specified by the ship location Partner.

13. The system as claimed in claim 12 wherein the appointment-making privileges specified by the ship location Partner include the privilege to request a pre-appointment, the privilege to request a repeating standing appointment, and the privilege to self-appoint appointments.

14. The system as claimed in claim 13 wherein the ship location Partner may elect to manually review and approve or decline the appointment reservation requests and to auto-accept the appointment reservation requests for any other Partners that have not been granted self-appointing privileges by that ship location Partner after the appointment request auto-approval aging time specified by the ship location Partner has elapsed.

15. The system as claimed in claim 12 wherein the ship location is owned by a Partner.

16. The system as claimed in claim 12 wherein the ship location is a third party owned facility serving one or more Partners.

17. The system as claimed in claim 10 wherein one Partner is a carrier.

18. The system as claimed in claim 10 wherein at least one Partner is a shipper.

19. The system as claimed in claim 10 wherein a Partner may query and view appointment information for any appointment reservation request and for any approved appointment reservation provided that the appointment reservation is relevant to that Partner including the entirety of a multi-Partner multi-segment tour to facilitate Partner collaboration in the planning of multi-Partner shipments.

20. The system as claimed in claim 19 wherein the entirety of the multi-Partner multi-segment tour includes continuous move and multi-stop and delivery shipments.

21. The system as claimed in claim 20 wherein the appointment-making privileges include the privilege to request a pre-appointment, the privilege to request repeating standing appointments, and the privilege to self-appoint appointments; the ship location Partner may manually review and accept and reject the appointment requests and auto-accept the requests after a location-specified appointment request auto-approval aging time has elapsed; the ship location is owned by a Partner; the ship location is a third party owned facility serving one or more Partners; at least one Partner is a carrier; at least one Partner is a shipper; a Partner may query and view appointment information for any appointment reservation request and for any approved appointment reservation provided that the appointment reservation is relevant to that Partner including the entirety of a multi-Partner multi-segment tour so as to facilitate Partner corroboration in the planning of the multi-Partner shipment; and the entirety of the multi-Partner multi-segment tour includes continuous move and multi-stop pick-up and delivery shipments.
